(19) United States
(12) Patent Application Publication
(10) Pub. No.: US 2005/0284694 A1
(43) Pub. Date: Dec. 29, 2005

(54) Energy absorber device for a life line

(75) Inventors: Nicolas Faye, Saint-Viatre (FR); Benoit Fourgeot, Bourges (FR)

Correspondence Address: GREENBLUM & BERNSTEIN, P.L.C., 1950 ROLAND CLARKE PLACE, RESTON, VA, 20191, US

(73) Assignee: BACOU DALLOZ VIERZON, Vierzon (FR)

(21) Appl. No.: 11/159,310

(22) Filed: Jun. 23, 2005

(30) Foreign Application Priority Data
Jun. 29, 2004 (FR) 04 07134

(51) Int. Cl. A62B 37/00

(52) U.S. Cl. 182/3

(57) ABSTRACT

Energy absorbing device including a first plate superposed on a second plate, the first and second plates being adapted to slide relative to one another, wherein the first plate has a first cut-out composed of a plurality of first strips and the second plate has a second cut-out composed of a plurality of second strips. Further, a first finger is attached to the first plate extending through the second cut-out portion.

### CROSS-REFERENCE TO RELATED APPLICATIONS

The present application claims priority under U.S.C. § 119 of French Patent Application No. 04 07134 filed Jun. 29, 2004, the disclosure of which is hereby expressly incorporated by reference herein in its entirety.

### BACKGROUND OF THE INVENTION

1. Field of the Invention

The present invention relates to a device connected to a safety cable and/or lifeline to absorb energy from an accidental fall of a person or object, thus limiting the forces at the anchorage points of the safety cable and/or lifeline. For example, the device can be inserted into a horizontal cable stretched along a building, so as to represent a lifeline and along which slides a slider, e.g., a ring, connected by a link to a harness worn by a person and/or object high above ground.

2. Discussion of Background Information

The invention relates to devices inserted into the cable and/or lifeline which, if a person or object accidentally falls from high above the ground, the devices will absorb the loaded tension from the person or object falling and reduce the forces at the anchorage points of the cable and/or lifeline.

The present invention can improve devices related to safety cables and/or lifelines by having a simple structure, lower manufacturing costs, as well as being efficient and safe.

### SUMMARY OF THE INVENTION

The present invention provides an improved energy absorber device for a cable and/or lifeline for a person or object that accidentally falls while high above the ground. The device can be adapted to be inserted in series with a cable and/or a lifeline disposed along a building, which is attached to a harness, and intern connected to the person or object. The device includes a first outer end and a second outer end that may include holes or apertures for fixing cables or lifelines thereto. For example, the first outer end and the second outer end may be attached in series with a cable, wherein the cable is attached between two elements, e.g., along two front sides of a building, so the cable stretches across the front side of the building. Further, the device includes two superposed plates adapted to slide relative to each other, each plate may have a cut-out forming a series of strips extending transversely to the longitudinal axis of the plate and a finger passing through the cut-out of the other plate, in the vicinity of the holes for fixing the ends of the cable.

In the event of an accidental fall from a person or object high above ground, the device may absorb the energy from the person or object falling by the fingers breaking the strips, thus damping the tension of the cable or lifeline.

### BRIEF DESCRIPTION OF THE DRAWINGS

The present invention is further described in the detailed description which follows, in which like reference numerals represent similar parts throughout the several views of the drawings, and wherein:

FIG. 1 illustrates a perspective view of the device attached to a cable;

FIG. 2 illustrates an enlarged perspective front view of the device;

FIG. 3 illustrates an enlarged perspective back view of the device;

FIG. 4 illustrates a perspective view of the device attached to one of a cable and lifeline that is under a tension.

### DETAILED DESCRIPTION OF THE PRESENT INVENTION

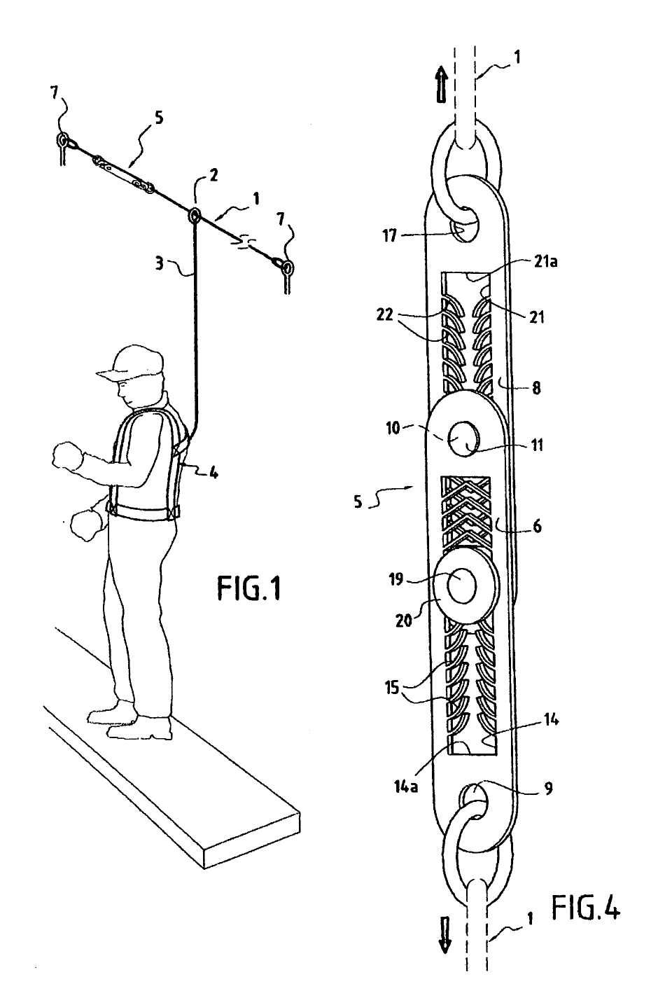

FIG. 1 shows the device 5 attached to a cable 1, by a first hole 9 of the first plate 6 and a first hole 17 of the second plate 8, wherein the cable is fixed between two secure elements 7, e.g., two outer ends of a front side of a building. One end of a lifeline 3 can be attached to a safety harness 4, e.g., a fastening or securing device, secured to the person and/or object, and the other end of the lifeline can be slideably attached by a fastening element 2 to the cable 1. Accordingly, the person or object attached to the device 5 (via cable 1, fastening element 2, lifeline 3 and safety harness 4), can move between the two secure elements 7, while secured to the cable and/or lifeline and prevented from falling from high ground. For example, a person and/or object may be working (or operating) high above ground, and in the event of an accidental fall from the person and/or object, the device 5 may absorb the energy from the person and/or object falling, thus damping the tension of the cable 1 and/or lifeline 3. The resulting effect of the device 5 may be to reduce injury to the person or damage to the object, from the damping of the tension of the cable 1 and/or lifeline 3, as well as reduce the forces at the anchorage points of the cable and/or lifeline.

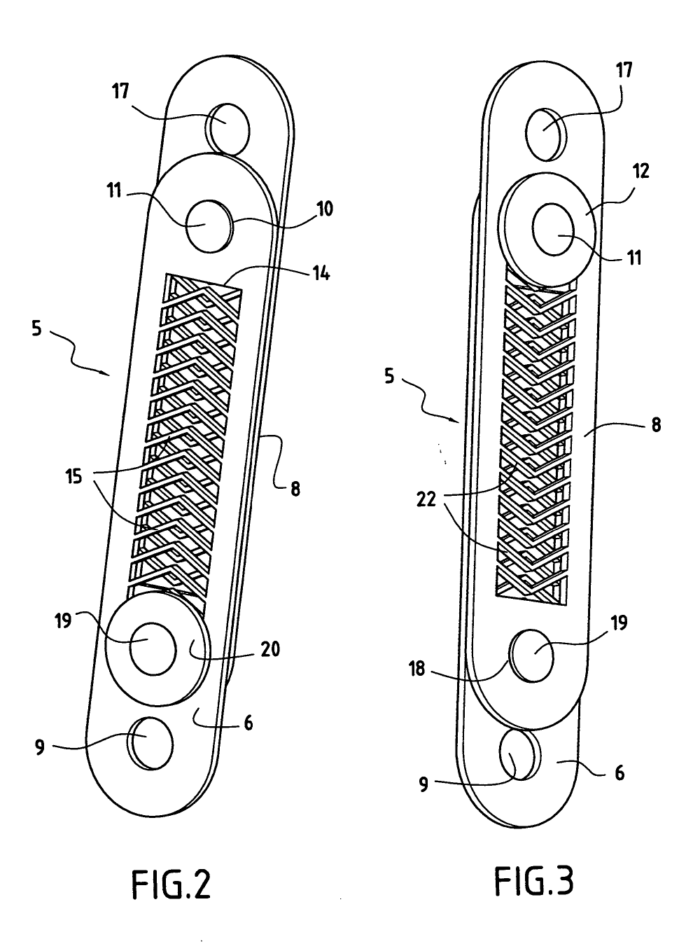

FIG. 2 shows an enlarged front view of the device 5, wherein the first plate 6 may include a longitudinal cut-out 14 providing a series of parallel strips 15 arranged transverse to the longitudinal axis of the first plate 6. The strips 15 can be V-shaped with the end point of the V-shape, facing toward a rivet 11, e.g., a finger or the like. The first plate 6 may have at one end a hole 9 for fixing the cable 1 and at the other end a hole 10, in which is fixed a finger, e.g., a rivet 11.

Still referring to FIG. 2, the second plate 8 may be similar or identical to the first plate 6 and disposed with a reverse orientation relative to the first plate 6. The second plate 8 may have at one end a hole 17 for fixing the cable 1 thereto, and at the other end a hole 18 in which is fixed a finger, e.g., a rivet 19, on which a washer 20 can be mounted.

FIG. 3 shows an enlarged back view of the device 5, wherein the second plate 8 may include a cut-out 21 forming a series of parallel strips 22 transverse to the longitudinal axis of the second plate 8. The strips 22 can be V-shaped with the end point of the V-shape facing toward a rivet 19, e.g., a finger or the like.

FIG. 4 shows a view of the device 5, in a position connected in series with cable 1, wherein one end of the cable is attached to hole 17 pulling in one direction and the other end of the cable 1 is attached to hole 9, pulling in the opposite direction. Because of the simultaneous forces applied to both ends of the device, e.g., from a falling person and/or object, causes tension on the cable 1, rivet 11 passes through the cut-out 21 of the second plate 8, and is lodged between an end 21a of the cut-out 21 and the strips 22 adjacent end 21a, with the washer 12 bearing on the free face of the plate 8. Further, rivet 19 passes through the cut-out 14 and is disposed between the end 14a of the cut-out 14 and the strips 15 adjacent end 14a, with the washer 20 bearing against the free face of the plate 6.

Still referring to FIG. 4, if a person and/or object falls accidentally while attached to the device 5 from a high above ground, the cable 1 can be tensioned and, because of the weight of the person and/or object, the lifeline 3 would be loaded in tension, resulting in plate 6 sliding relative to plate 8, such that the rivet 11 breaks the strips 22 and rivet 19 breaks the strips 15. Further, the fingers (11 and 19), e.g., rivots, can absorb the energy from the person or object falling by breaking the strips (22 and 15), thus damping the tension of the cable or lifeline.

The present invention can have a simple structure, low manufacturing costs, as well as being efficient and safe for devices related to safety cables and/or lifelines.

Of course, the invention is not limited to the embodiment that has just been described and shown. Numerous modifications of detail may be made thereto without departing from the scope of the invention.

1-4. (canceled)

5. A device comprising:
a first plate superposed on a second plate, the first and second plates being adapted to slide relative to one another, wherein the first plate has a first cut-out composed of a plurality of first strips and the second plate has a second cut-out composed of a plurality of second strips; and
a first finger is attached to the first plate extending through the second cut-out portion.

6. The device of claim 5, wherein the device is an energy absorbing device.

7. The device of claim 6, wherein one of the first cut-out portion is arranged between a first end and a second end of the first plate and the second cut-out portion is arranged between a first end and a second end of the second plate.

8. The device of claim 7, wherein one of the first end of the first plate has a first hole and the second end of the first plate has a second hole, and the first end of the second plate has a first hole and the second end of the second plate has a second hole.

9. The device of claim 5, wherein a second finger is attached to the second plate extending through the first cut-out portion;

10. The device of claim 9, wherein one of the first finger is a rivet and the second finger is a rivet.

11. The device of claim 9, wherein one of the first finger has at least one second washer and the second finger has at least one first washer.

12. The device of claim 10, wherein the at least one first washer and the second finger are arranged on a first free face of the first plate.

13. The device of claim 11, wherein the at least one second washer and the first finger are arranged on a second free face of the second plate.

14. The device of claim 5, wherein the plurality of first strips are arranged transverse to a longitudinal axis of the first plate.

15. The device of claim 14, wherein the plurality of first strips are V-shaped with an end point of the V-shape facing toward the second end of the first finger.

16. The device of claim 5, wherein the plurality of second strips are arranged transverse to a longitudinal axis of the second plate.

17. The device of claim 16, wherein the plurality of second strips are V-shaped with an end point of the V-shape facing toward the second end of the second finger.

18. The device of claim 7, wherein the first end of the first plate and the first end of the second plate attaches in series with one of a cable and a lifeline, so as to provide an energy absorbing effect when a tension is applied to one of the cable and lifeline.

19. The device of claim 5, wherein the first plate and the second plate are structurally identical and are reversely oriented with respect to each other.

20. The device of claim 5, further comprising:
an end of the first plate and an end of the second plate is attached in series with one of a cable and a lifeline;
wherein the tension applied to one of the cable and the lifeline, causes the first finger to pass through the plurality of second strips and the second finger to pass through the plurality of first strips, such that the tension is absorbed by the first and second fingers passing through the plurality of second and first strips, respectively.

21. An energy absorbing device comprising:
a first plate superposed on a second plate, the first and second plates being adapted to slide relative to one another, wherein the first plate has a cut-out composed of a series of strips;
a finger attached to the second plate extending through the cut-out of the first plate;
wherein an end of the first plate and an end of the second plate is attached in series with one of a cable and a lifeline.
